(19) United States
(12) Patent Application Publication
(10) Pub. No.: US 2026/0239190 A1
(43) Pub. Date: Aug. 13, 2026

(54) COMMUNICATION METHOD, ELECTRONIC DEVICE AND STORAGE MEDIUM

(71) Applicant: BEIJING XIAOMI MOBILE SOFTWARE CO., LTD., Beijing (CN)

(72) Inventor: Yajun CHENG, Beijing (CN)

(73) Assignee: BEIJING XIAOMI MOBILE SOFTWARE CO., LTD., Beijing (CN)

(21) Appl. No.: 19/154,403

(22) PCT Filed: Feb. 10, 2023
(86) PCT No.: PCT/CN2023/075537

§ 371 Date: Aug. 7, 2025

(51) Int. Cl. H04W 52/02; H04L 5/00; H04W 28/02

(52) U.S. Cl. CPC H04W 52/0203; H04L 5/0053; H04W 28/0268

(57) ABSTRACT

A communication method is performed by a station (STA), and includes: determining a first frame, wherein the first frame comprises restricted target wake time (R-TWT) adjustment information, the R-TWT adjustment information indicates an adjustment operation performed by the STA on an R-TWT service period (SP), and the adjustment operation comprises extending the R-TWT SP or shortening the R-TWT SP; and sending the first frame.

### CROSS-REFERENCE TO RELATED APPLICATIONS

This application is the U.S. National Stage Application of International Application No. PCT/CN2023/075537, filed on Feb. 10, 2023, the entire disclosure of which is incorporated herein by reference.

### TECHNICAL FIELD

The present disclosure relates to a technical field of mobile communication, and in particular to a communication method, an electronic device, and a storage medium.

### BACKGROUND

In a currently studied wireless-fidelity (Wi-Fi) technology, to support an energy-saving work under a large-scale Internet of Things (IoT) device, a target wake time (TWT) mechanism is proposed; meanwhile, to ensure transmission of latency sensitive traffic, a restricted target wake time (R-TWT) mechanism is proposed.

### SUMMARY

According to a first aspect, the embodiments of the present disclosure provide a communication method, performed by a station (STA), including:
determining a first frame, in which the first frame includes R-TWT adjustment information, the R-TWT adjustment information indicates an adjustment operation performed by the STA on an R-TWT service period (SP), and the adjustment operation includes extending the R-TWT SP or shortening the R-TWT SP; and
sending the first frame.

According to second aspect, the embodiments of the present disclosure provide a communication method, performed by an access point (AP), including:
receiving a first frame, in which the first frame includes R-TWT adjustment information, the R-TWT adjustment information indicates an adjustment operation performed by an STA on an R-TWT SP, and the adjustment operation includes extending the R-TWT SP or shortening the R-TWT SP.

According to third aspect, the embodiments of the present disclosure provide an STA, including a memory, a processor, and a computer program stored on the memory and executable by the processor, in which the processor is configured to perform the method according to the first aspect.

### BRIEF DESCRIPTION OF THE DRAWINGS

In order to clearly illustrate technical solutions of embodiments of the present disclosure, a brief description of accompanying drawings used in the embodiments is given below. Obviously, the accompanying drawings in the following descriptions are only part embodiments of the present disclosure, and for those skilled in the art, other accompanying drawings can be obtained according to these accompanying drawings without creative labor.

FIG. 1 is a first flowchart of a communication method according to an embodiment of the present disclosure.

FIG. 2 is a schematic diagram of an application scenario of a communication method according to an embodiment of the present disclosure.

FIG. 3 is a second flowchart of a communication method according to an embodiment of the present disclosure.

FIG. 4 is a first block diagram of an electronic device according to an embodiment of the present disclosure.

FIG. 5 is a second block diagram of an electronic device according to an embodiment of the present disclosure.

FIG. 6 is a third block diagram of an electronic device according to an embodiment of the present disclosure.

### DETAILED DESCRIPTION

Reference will now be made in detail to illustrative embodiments, examples of which are illustrated in the accompanying drawings. The following description refers to the accompanying drawings in which the same numerals in different accompanying drawings represent the same or similar elements unless otherwise represented. The implementations set forth in the following description of illustrative embodiments do not represent all implementations consistent with the present disclosure. Instead, they are merely examples of apparatuses and methods consistent with aspects related to the embodiments of the present disclosure as recited in the appended claims.

The terms used in embodiments of the present disclosure are solely for the purpose of describing a particular embodiment and are not intended to limit the present disclosure. The terms “a/an” and “the” in a singular form used in embodiments and claims of the present disclosure are also intended to include a plural form, unless the context clearly indicates other meaning. It should also be understood that the term “and/or” as used herein refers to any or all possible combinations of one or more associated listed items. For example, A and/or B means A alone, A and B at the same time, and B alone. The character “/” generally indicates that the relationship between associated objects is an “or” relationship. The term “a plurality of” in the present disclosure refers to two or more than two. In this way, in the embodiments of the present disclosure, the term “a plurality of” can also be understood as “at least two”.

It should be understood that although the terms first, second, third, etc. may be used to describe various information in the embodiments of the present disclosure, such information should not be limited to these terms. These terms are used only to distinguish information in the same type from one another. For example, without departing from the scope of embodiments of the present disclosure, the first information may also be referred to as the second information, and similarly, the second information may be referred to as the first information. Depending on the context, words “if” and “in case that” used here may be interpreted as “when”, “while”, or “in response to determining . . . ”.

Technical solutions in the embodiments of the present disclosure will be clearly and completely described below with reference to the accompanying drawings in embodiments of the present disclosure. Obviously, the embodiments described here are only part of the embodiments of the present disclosure and are not all embodiments of the present disclosure. Based on the embodiments of the present disclosure, other embodiments obtained by those skilled in the art without creative labor are within the scope of the present disclosure.

The embodiments of the present disclosure provide a communication method, an electronic device, and a storage medium, so as to further improve the R-TWT mechanism and further reduce the power consumption of the Wi-Fi network.

The method and device are based on a same inventive concept. Since a principle for solving a problem is similar between the method and device, an implementation of the method and an implementation of the device may cross-reference each other, with redundant descriptions omitted for brevity.

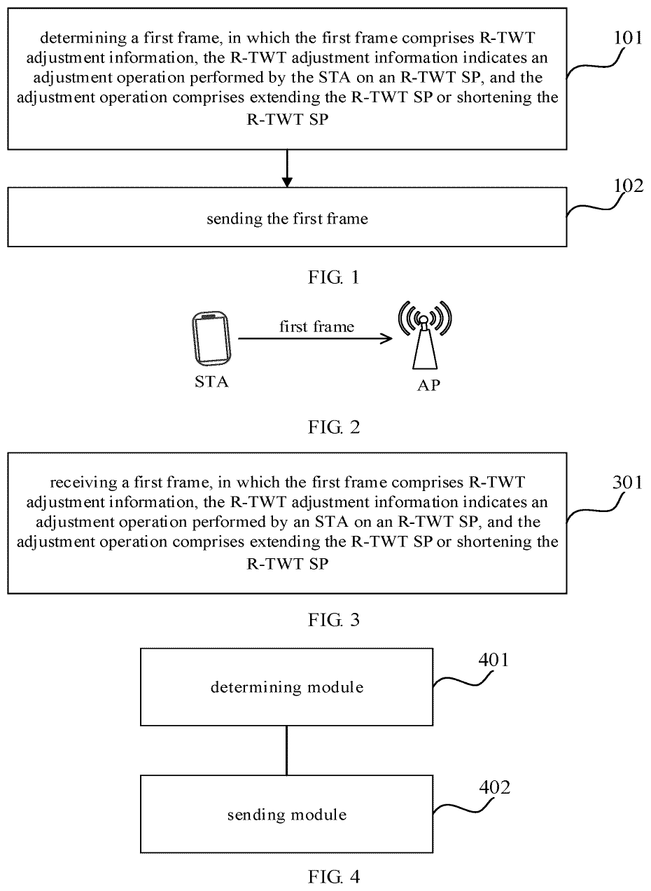

As shown in FIGS. 1 and 2, the embodiments of the present disclosure provide a communication method. Optionally, the method may be performed by a station (STA). Optionally, in the embodiments of the present disclosure, an access point (AP) is, for example, a device with a wireless-to-wired bridging function, where the AP is responsible for extending a service provided by a wired network to a wireless network. The STA is, for example, an electronic device with a wireless network access function, providing a frame delivery service to transmit information.

Referring to FIG. 2, the STA determines a first frame and transmits the first frame to the AP. The first frame includes the R-TWT adjustment information, which indicates the adjustment operation performed by the STA on an R-TWT service period (SP).

Optionally, in the embodiments of the present disclosure, the AP and the STA may be devices supporting a multi-link operation, for example, which are respectively called an AP multi-link device (MLD) and a non-AP MLD. The AP MLD may represent an AP supporting a multi-link communication function, and the non-AP MLD may represent an STA supporting a multi-link communication function.

Specifically, as shown in FIG. 1, the method may include S101 and S102.

At S101, a first frame is determined, in which the first frame includes R-TWT adjustment information, the R-TWT adjustment information indicates an adjustment operation performed by the STA on an R-TWT SP, and the adjustment operation includes extending the R-TWT SP or shortening the R-TWT SP.

TWT technology is an energy-saving technology aimed at further reducing the power consumption of the Wi-Fi network. Specifically, the TWT technology enables the STA and the AP to negotiate an SP to determine a time and a frequency for the STA to sleep and wake up. The STA remains active and communicates in the SP, so that the STA may sleep outside the SP to save energy. In addition, the TWT technology enables the AP to provide higher-quality services to a plurality of STAs, minimizing contention or overlap, and improving the spectrum efficiency while reducing the power consumption of the Wi-Fi network.

In a low-latency transmission scenario, real-time data traffic from numerous applications has strict delay requirements, for example, an average/maximum delay ranges from several milliseconds to tens of milliseconds, and the application demands minimal jitter and high reliability for the real-time data traffic. To further ensure a communication of a low-latency service, the R-TWT is proposed based on the TWT technology. The R-TWT mechanism enables the AP to use an enhanced media access protection mechanism and a resource reservation mechanism to provide a more predictable latency to differentiate delay-sensitive traffic from other traffic, which allows the AP to reduce a latency and/or jitter in a worst situation, and to deliver a higher-reliability service.

Specifically, the R-TWT serves the low-latency service, such as a service with an average delay below 10 milliseconds (ms). In the R-TWT SP, only communication of a service identified as the low-latency service is performed, while other communication services are suspended or deferred within this phase, thereby ensuring a transmission of the low-latency service. In the embodiments of the present disclosure, a scheduling device of the R-TWT (e.g., AP, also called scheduling AP) may preset an initial R-TWT SP when establishing the R-TWT. Within the initial R-TWT SP, the STA, as a scheduled device (or a scheduled STA), may adjust the initial R-TWT SP, for example, extending or shortening the R-TWT SP. Therefore, the STA determines the first frame carrying the R-TWT adjustment information (e.g., R-TWT wake duration adjustment). The R-TWT adjustment information indicates the adjustment operation performed by the STA on the R-TWT SP, enabling other devices to be informed of the adjustment operation.

At S102, the first frame is sent.

The STA sends the first frame carrying the R-TWT adjustment information, which indicates the adjustment operation performed by the STA on the R-TWT SP, and the adjustment operation includes extending the R-TWT SP or shortening the R-TWT SP. On the one hand, after the initial R-TWT SP ends, the STA transmitting the low-latency service may not send any frame to its associated AP. If the initial R-TWT SP is too short, the low-latency service transmitted between the STA and the AP may be interrupted, which may degrade a communication quality. On the other hand, communication of other non-low-latency service is performed in the initial R-TWT SP. If the initial R-TWT SP is too long, communication resources may be wasted. Therefore, by extending or shortening the R-TWT SP, the STA enhances the transmission quality of the low-latency service and avoids waste of the communication resources.

Optionally, in the embodiments of the present disclosure, the first frame includes a TWT setup frame. Usually, the R-TWT SP is a periodic SP. In the case that the STA adjusts a duration of the R-TWT SP, the STA sends information frames that the R-TWT SP is extended or the R-TWT SP terminated in advance within each SP respectively, which will cause additional signaling overhead. Especially when the SP is too short, an extra signaling may cause interruption or suspension of the low-latency service. Therefore, carrying the R-TWT adjustment information in the TWT setup frame avoids informing the adjustment information in each R-TWT SP respectively, and reduces the signaling overhead.

The embodiments of the present disclosure provide a communication method. Optionally, the method may be performed by an STA. The method includes:
extending the R-TWT SP, carrying the R-TWT adjustment information in the first frame, and sending the first frame under at least one of following Conditions 1 to 3:

Condition 1: receiving a second frame sent by a scheduling device of the R-TWT SP within last N interframe spaces (IFSs) before an end of the R-TWT SP, in which the second frame includes an acknowledgement (ACK) frame, a block ACK frame or a multi-station block ACK frame, and a More Data subfield of the second frame is set to a first value.

Optionally, N may be a positive integer, for example, 1, 2, etc., and the first value may be set to 1. The first value indicates that the AP acknowledges that there is still low-latency service data to be transmitted subsequently. The second frame may be: an ACK frame with the More Data subfield set to 1, a block ACK frame with the More Data subfield set to 1, or a multi-station block ACK frame with the More Data subfield set to 1. When the AP acknowledges that there is still low-latency service data to be transmitted subsequently, the STA proactively extends the R-TWT SP to avoid interruption of a low-latency service transmission.

Condition 2: not receiving a third frame sent by the scheduling device of the R-TWT at the end of the R-TWT SP, in which the third frame includes an ACK frame, a block ACK frame or a multi-station block ACK frame. The third frame indicates that the AP acknowledges receipt of low-latency service data transmitted by the STA. If the third frame is not received at the end of the R-TWT SP, it indicates that the low-latency service data may not be completed transmitted. In this case, the STA proactively extends the R-TWT SP.

Condition 3: receiving a fourth frame sent by the scheduling device before the end of the R-TWT SP, in which an end of service period (EOSP) subfield of a service (QoS) control field of the fourth frame is set to a second value, for example, 0, indicating that an SP of the fourth frame has not yet ended. In this case, the STA proactively extends the R-TWT SP.

The embodiments of the present disclosure provide a communication method.

Optionally, the method may be performed by an STA. The method includes:
determining a first frame, in which the first frame includes R-TWT adjustment information, the R-TWT adjustment information indicates an adjustment operation performed by the STA on an R-TWT SP; and
sending the first frame.

The adjustment operation includes extending the R-TWT SP. Extending the R-TWT SP includes:
extending the R-TWT SP based on a preset R-TWT adjustment time. For example, an R-TWT adjustment time is preset, for example, 5 ms or other time values. When extending the R-TWT SP, adjustment is made based on a preset time value.

The embodiments of the present disclosure provide a communication method. Optionally, the method may be performed by an STA. The method includes:
shortening the R-TWT SP, carrying the R-TWT adjustment information in the first frame, and sending the first frame under at least one of following Conditions 4 to 5:

Condition 4: receiving a fifth frame sent by the scheduling device of the R-TWT SP within last M IFSs before the end of the R-TWT SP, in which the fifth frame includes an ACK frame, a block ACK frame or a multi-station block ACK frame, and a More Data subfield of the fifth frame is set to a third value, for example, 0.

Optionally, M may be a positive integer, for example, 1, 2, etc. Setting the third value to 0 indicates that the AP acknowledges that there is no low-latency service data to be transmitted subsequently. The fifth frame may be: an ACK frame with the More Data subfield set to 0, a block ACK frame with the More Data subfield set to 0, or a multi-station block ACK frame with the More Data subfield set to 0. When the AP acknowledges that there is no low-latency service data to be transmitted subsequently, the STA proactively shortens the R-TWT SP to avoid the R-TWT SP being too long, thereby preventing the waste of the communication resources.

Condition 5: not transmitting or receiving data within a preset R-TWT timeout before the end of the R-TWT SP. That is, if the STA neither receives nor transmits the data within the preset R-TWT timeout, the low-latency service may have been completed transmitted, and the STA may proactively shorten the R-TWT SP.

The embodiments of the present disclosure provide a communication method. Optionally, the method may be performed by an STA. The method includes:
determining a first frame, in which the first frame includes R-TWT adjustment information, the R-TWT adjustment information indicates an adjustment operation performed by the STA on an R-TWT SP; and
sending the first frame.

The adjustment operation includes shortening the R-TWT SP. Shortening the R-TWT SP includes:
shortening the R-TWT SP based on a preset R-TWT adjustment time; or
ending the R-TWT SP in advance when the R-TWT timeout expires.

When shortening the R-TWT SP, the STA may shorten the R-TWT SP based on the preset R-TWT adjustment time. For example, if the R-TWT adjustment time is set to 5 ms, the R-TWT SP may be shortened by 5 ms. In addition, the STA may also end the R-TWT SP in advance.

In an optional embodiment, the method includes:
receiving a sixth frame, in which the sixth frame includes the R-TWT timeout.

The R-TWT timeout included in the sixth frame may be sent by the scheduling device.

In an optional embodiment, the sixth frame is a management frame including an R-TWT parameter set field or an extreme high throughput (EHT) operation field, in which the management frame including the R-TWT parameter set field is, for example, a beacon frame, and the management frame including the EHT operation field is, for example, a beacon frame, a probe response frame, an association response frame, or a re-association response frame.

As a first example, when the sixth frame is a management frame including the R-TWT parameter set field, an R-TWT timeout subfield may be added to a broadcast TWT parameter set field format. The Broadcast TWT parameter set field format is shown in Table 1 below.

TABLE 1

| | | | |
|---|---|---|---|
| . . . | Broadcast TWT Info | . . . | R-TWT Timeout |

Furthermore, the broadcast TWT information subfield of the sixth frame includes an R-TWT timeout present identifier bit.

The R-TWT timeout present identifier bit is set to a fourth value, indicating that the sixth frame includes the R-TWT timeout. The fourth value is, for example, 1. If an R-TWT timeout present is set to 1, it indicates that the broadcast TWT information subfield includes the R-TWT timeout subfield; if the R-TWT timeout present is set to 0, it indicates that the broadcast TWT information subfield does not include the R-TWT timeout subfield. As a second example, when the sixth frame is a management frame including the R-TWT parameter set field, the R-TWT timeout present identifier bit may be added to the broadcast TWT information subfield. A format of the broadcast TWT information subfield is shown in Table 2 below.

TABLE 2

| | | |
|---|---|---|
| . . . | R-TWT Timeout Present | . . . |
| | Identifier Bit | |

In an optional embodiment, the R-TWT adjustment information is carried in the R-TWT parameter set field, for example, included in a TWT setup frame including an R-TWT parameter set sent by a scheduled device or a scheduling device. For example, an R-TWT wake duration adjustment subfield may be added to the broadcast TWT parameter set field format, as shown in Table 3 below.

TABLE 3

| | | | |
|---|---|---|---|
| . . . | Broadcast TWT | . . . | R-TWT Wake Duration |
| | Info | | Adjustment Info (optional) |

As a third example, when the sixth frame is the management frame including the EHT operation field, the preset R-TWT timeout subfield above is included in EHT operation information, as shown in Table 4 below.

TABLE 4

| | | |
|---|---|---|
| . . . | R-TWT Timeout | . . . |

In an optional embodiment, a broadcast TWT information subfield of the first frame includes an R-TWT wake duration adjustment present indicator bit; and
the R-TWT wake duration adjustment present indicator bit (or the R-TWT adjustment present indicator bit) is set to a fifth value to indicate that the first frame includes the R-TWT adjustment information.

If the fifth value is set to 1, that is, an R-TWT wake duration adjustment present indicator bit of the first frame is set to 1, it indicates that the R-TWT wake duration adjustment subfield is included in the broadcast TWT parameter set field. If the R-TWT wake duration adjustment present indicator bit is set to 0, it indicates that the R-TWT wake duration adjustment subfield is not included in the broadcast TWT parameter set field.

A format of the broadcast TWT parameter set field is shown in Table 5 below.

TABLE 5

| | | |
|---|---|---|
| . . . | R-TWT Wake Duration | . . . |
| | Adjustment Present | |
| | Indicator Bit | |

The embodiments of the present disclosure provide a communication method. Optionally, the method may be performed by an STA. The method includes:
determining a first frame, in which the first frame includes R-TWT adjustment information, the R-TWT adjustment information indicates an adjustment operation performed by the STA on an R-TWT SP, and the adjustment operation includes extending the R-TWT SP or shortening the R-TWT SP; and
sending the first frame.

The first frame includes nominal minimum TWT wake duration information.

The nominal minimum TWT wake duration information includes: a sum of a preset minimum TWT wake duration and a time indicated by the R-TWT adjustment information; or a difference between a preset minimum TWT wake duration and a time indicated by the R-TWT adjustment information; or a difference between a preset minimum TWT wake duration and an R-TWT timeout. The preset minimum TWT wake duration is an initial minimum TWT wake duration. When the STA determines that the R-TWT SP is too short or too long and adjusts the R-TWT SP, the STA may send a TWT setup frame to its associated scheduling device and adjust a value of the nominal minimum TWT wake duration in a broadcast TWT parameter set field (where a broadcast TWT identifier (ID) corresponding to the TWT setup frame is located).

The embodiments of the present disclosure provide a communication method. Optionally, the method may be performed by an STA. The method includes:
determining a first frame, in which the first frame includes R-TWT adjustment information, the R-TWT adjustment information indicates an adjustment operation performed by the STA on an R-TWT SP, and the adjustment operation includes extending the R-TWT SP or shortening the R-TWT SP; and
sending the first frame.

The first frame includes nominal minimum TWT wake duration information.

Specifically, a second frame sent by a scheduling device of the R-TWT SP is received within last N IFSs before an end of the R-TWT SP, and the nominal minimum TWT wake duration information includes a sum of a preset minimum TWT wake duration and a time indicated by the R-TWT adjustment information;
a third frame sent by the scheduling device is not received before the end of the R-TWT SP, and the nominal minimum TWT wake duration information includes a sum of a preset minimum TWT wake duration and an R-TWT timeout; or
a fourth frame sent by the scheduling device of the R-TWT SP is received before the end of the R-TWT SP, and the nominal minimum TWT wake duration information includes a sum of a preset minimum TWT wake duration and an R-TWT timeout.

When the scheduled device determines that the R-TWT SP is too short, the scheduled device adjusts a value of a nominal minimum TWT wake duration field in the broadcast TWT parameter set field, and changes it to the sum of an initial value of the nominal minimum TWT wake duration field and a value of an R-TWT wake duration adjustment field.

The embodiments of the present disclosure provide a communication method. Optionally, the method may be performed by an STA. The method includes:
determining a first frame, in which the first frame includes R-TWT adjustment information, the R-TWT adjustment information indicates an adjustment operation performed by the STA on an R-TWT SP, and the adjustment operation includes extending the R-TWT SP or shortening the R-TWT SP; and
sending the first frame.

The first frame includes nominal minimum TWT wake duration information.

Specifically, a fifth frame sent by the scheduling device of the R-TWT SP is received within last M IFSs before the end of the R-TWT SP, and the nominal minimum TWT wake duration information includes the difference between the preset minimum TWT wake duration and the time indicated by the R-TWT adjustment information; or
data is not transmitted in a preset R-TWT timeout before the end of the R-TWT SP, and the nominal minimum TWT wake duration information includes a difference between a preset minimum TWT wake duration and an R-TWT timeout.

When the scheduled device determines that the R-TWT SP is too long, the scheduled device adjusts a value of a nominal minimum TWT wake duration field in a broadcast TWT parameter set field, and changes it to a difference between an initial value of the nominal minimum TWT wake duration field and a value of the R-TWT wake duration adjustment field, or a difference between the initial value of the nominal minimum TWT wake duration field and a value of an R-TWT timeout field.

The embodiments of the present disclosure provide a communication method. Optionally, the method may be performed by an STA. The method includes:
determining a first frame, in which the first frame includes R-TWT adjustment information, the R-TWT adjustment information indicates an adjustment operation performed by the STA on an R-TWT SP, and the adjustment operation includes extending the R-TWT SP or shortening the R-TWT SP; and
sending the first frame.

Optionally, the method includes:
extending the R-TWT SP in at least one of following cases:
receiving a second frame sent by a scheduling device of the R-TWT SP within last N IFSs before an end of the R-TWT SP, in which the second frame includes an ACK frame, a block ACK frame or a multi-station block ACK frame, and a More Data subfield of the second frame is set to a first value;
not receiving a third frame sent by the scheduling device of the R-TWT at the end of the R-TWT SP, in which the third frame includes an ACK frame, a block ACK frame or a multi-station block ACK frame; or
receiving a fourth frame sent by the scheduling device before the end of the R-TWT SP, in which an EOSP subfield of a QoS control field of the fourth frame is set to a second value.

Optionally, extending the R-TWT SP includes:
extending the R-TWT SP based on a preset R-TWT adjustment time.

Optionally, the method includes:
shortening the R-TWT SP in at least one of following cases:
receiving a fifth frame sent by a scheduling device of the R-TWT SP within last M IFSs before the end of the R-TWT SP, in which the fifth frame includes an ACK frame, a block ACK frame or a multi-station block ACK frame, and a More Data subfield of the fifth frame is set to a third value; or
not transmitting or receiving data in a preset R-TWT timeout before the end of the R-TWT SP.

Optionally, shortening the R-TWT SP includes:
shortening the R-TWT SP based on a preset R-TWT adjustment time; or
ending the R-TWT SP in advance when the R-TWT timeout expires.

Optionally, the method includes:
receiving a sixth frame, in which the sixth frame includes the R-TWT timeout.

Optionally, the sixth frame is a management frame including an R-TWT parameter set field or an EHT operation field.

Optionally, a broadcast TWT information subfield of the sixth frame includes an R-TWT timeout present indicator bit; and
the R-TWT timeout present indicator bit is set to a fourth value to indicate that the sixth frame includes the R-TWT timeout.

Optionally, the R-TWT adjustment information is carried in an R-TWT parameter set field.

Optionally, a broadcast TWT information subfield of the first frame includes an R-TWT wake duration adjustment present indicator bit; and
the R-TWT wake duration adjustment present indicator bit is set to a fifth value to indicate that the first frame includes the R-TWT adjustment information.

Optionally, the first frame includes nominal minimum TWT wake duration information, and
the nominal minimum TWT wake duration information includes: a sum of a preset minimum TWT wake duration and a time indicated by the R-TWT adjustment information; or a difference between a preset minimum TWT wake duration and a time indicated by the R-TWT adjustment information; or a difference between a preset minimum TWT wake duration and the R-TWT timeout.

Optionally, in the case that the second frame sent by the scheduling device of the R-TWT SP is received within the last N IFSs before the end of the R-TWT SP, the nominal minimum TWT wake duration information includes the sum of the preset minimum TWT wake duration and the time indicated by the R-TWT adjustment information;
in the case that the third frame sent by the scheduling device is not received before the end of the R-TWT SP, the nominal minimum TWT wake duration information includes a sum of the preset minimum TWT wake duration and the R-TWT timeout; or
in the case that the fourth frame sent by the scheduling device of the R-TWT SP is received before the end of the R-TWT SP, the nominal minimum TWT wake duration information includes a sum of the preset minimum TWT wake duration and the R-TWT timeout.

Optionally, in the case that the fifth frame sent by the scheduling device of the R-TWT SP is received within the last M IFSs before the end of the R-TWT SP, the nominal minimum TWT wake duration information includes the difference between the preset minimum TWT wake duration and the time indicated by the R-TWT adjustment information; or
in the case that data is not transmitted in the preset R-TWT timeout before the end of the R-TWT SP, the nominal minimum TWT wake duration information includes the difference between the preset minimum TWT wake duration and the R-TWT timeout.

Optionally, the first frame includes a TWT setup frame.

In the embodiments of the present disclosure, the STA sends the first frame carrying the R-TWT adjustment information, which indicates the adjustment operation performed by the STA on the R-TWT SP, and the adjustment operation includes extending the R-TWT SP or shortening the R-TWT SP. On the one hand, after an initial R-TWT SP ends, the STA transmitting the low-latency service may not send any frame to its associated AP. If the initial R-TWT SP is too short, the low-latency service transmitted between the STA and the AP may be interrupted, which may degrade a communication quality. On the other hand, communication of other non-low-latency service is not performed in the initial R-TWT SP. If the initial R-TWT SP is too long, communication resources may be wasted. Therefore, by extending or shortening the R-TWT SP, the STA enhances the transmission quality of the low-latency service and avoids waste of the communication resources.

Referring to FIG. 3, the embodiments of the present disclosure provide a communication method. Optionally, the method may be performed by an AP, in which the AP may be a scheduling device of the R-TWT SP. The method may include S301.

At S301, a first frame is received, in which the first frame includes R-TWT adjustment information, the R-TWT adjustment information indicates an adjustment operation performed by an STA on the R-TWT SP, and the adjustment operation includes extending the R-TWT SP or shortening the R-TWT SP.

A WLAN architecture to which the communication method in the embodiments of the present disclosure is applied refers to FIG. 2 above, which will not be repeated here.

TWT technology is an energy-saving technology aimed at further reducing the power consumption of the Wi-Fi network. Specifically, the TWT technology enables the STA and the AP to negotiate an SP to determine a time and a frequency for the STA to sleep and wake up. The STA remains active and communicates in the SP, so that the STA may sleep outside the SP to save energy. In addition, the TWT technology enables the AP to provide higher-quality services to a plurality of STAs, minimizing contention or overlap, and improving the spectrum efficiency while reducing the power consumption of the Wi-Fi network.

In a low-latency transmission scenario, real-time data traffic from numerous applications has strict delay requirements, for example, an average/maximum delay ranges from several milliseconds to tens of milliseconds, and the application demands minimal jitter and high reliability for the real-time data traffic. To further ensure communication of a low-latency service, the R-TWT is proposed based on the TWT technology. The R-TWT mechanism enables the AP to use an enhanced media access protection mechanism and a resource reservation mechanism to provide a more predictable latency to differentiate delay-sensitive traffic from other traffic, which allows the AP to reduce a latency and/or jitter in a worst situation, and to deliver a higher-reliability service.

Specifically, the R-TWT serves the low-latency service, such as a service with an average delay below 10 ms. In the R-TWT SP, only communication of a service identified as the low-latency service is performed, while other communication services are suspended or deferred within this phase, thereby ensuring a transmission of the low-latency service. In the embodiments of the present disclosure, a scheduling device of the R-TWT (e.g., AP, also called scheduling AP) may preset an initial R-TWT SP when establishing the R-TWT. Within the initial R-TWT SP, the STA, as a scheduled device (or a scheduled STA), may adjust the initial R-TWT SP, for example, extending or shortening the R-TWT SP. Therefore, the STA determines the first frame carrying the R-TWT adjustment information (e.g., R-TWT wake duration adjustment). The R-TWT adjustment information indicates the adjustment operation performed by the STA on the R-TWT SP, enabling other devices to be informed of the adjustment operation.

The AP receives the first frame, obtains the R-TWT adjustment information carried in the first frame, and determines the adjustment operation performed by the STA on the R-TWT SP, and the adjustment operation includes extending the R-TWT SP or shortening the R-TWT SP. On the one hand, after an initial R-TWT SP ends, the STA transmitting the low-latency service may not send any frame to its associated AP. If the initial R-TWT SP is too short, the low-latency service transmitted between the STA and the AP may be interrupted, which may degrade communication quality. On the other hand, communication of other non-low-latency service is not performed in the initial R-TWT SP. If the initial R-TWT SP is too long, communication resources may be wasted. Therefore, by extending or shortening the R-TWT SP, the STA enhances the transmission quality of the low-latency service and avoids waste of the communication resources.

Optionally, in the embodiments of the present disclosure, the first frame includes a TWT setup frame. Usually, the R-TWT SP is a periodic SP. In the case that the STA adjusts a duration of the R-TWT SP, the STA sends information frames that the R-TWT SP is extended or the R-TWT SP terminated in advance within each SP respectively, which will cause additional signaling overhead. Especially when the SP is too short, an extra signaling may cause interruption or suspension of the low-latency service. Therefore, carrying the R-TWT adjustment information in the TWT setup frame avoids informing the adjustment information in each R-TWT SP respectively, and reduces the signaling overhead.

Optionally, in the embodiments of the present disclosure, the method includes:
sending a sixth frame, in which the sixth frame includes an R-TWT timeout, to indicate the R-TWT timeout to the STA.

Optionally, in the embodiments of the present disclosure, the sixth frame is a management frame including an R-TWT parameter set field or an EHT operation field, in which the management frame including the R-TWT parameter set field is, for example, a beacon frame, and the management frame including the EHT operation field is, for example, a beacon frame, a probe response frame, an association response frame, or a re-association response frame. A format of a broadcast TWT parameter set field may refer to Table 1 and will not be repeated here.

Optionally, in the embodiments of the present disclosure, the broadcast TWT information subfield of the sixth frame includes an R-TWT timeout present identifier bit.

The R-TWT timeout present identifier bit is set to a fourth value, indicating that the sixth frame includes the R-TWT timeout. The fourth value is, for example, 1. If an R-TWT timeout present is set to 1, it indicates that the broadcast TWT information subfield includes an R-TWT timeout subfield; if the R-TWT timeout present is set to 0, it indicates that the broadcast TWT information subfield does not include the R-TWT timeout subfield. A format of the broadcast TWT information subfield may refer to Table 2 and will not be repeated here.

The embodiments of the present disclosure provide a communication method. Optionally, the method may be performed by an AP, in which the AP may be a scheduling device of the R-TWT SP. The method may include:
receiving a first frame, in which the first frame includes R-TWT adjustment information, the R-TWT adjustment information indicates an adjustment operation performed by an STA on the R-TWT SP, and the adjustment operation includes extending the R-TWT SP or shortening the R-TWT SP, and
the R-TWT adjustment information is carried in an R-TWT parameter set field, for example, included in a TWT setup frame including an R-TWT parameter set sent by an R-TWT scheduled device or an R-TWT scheduling device. For example, an R-TWT wake duration adjustment subfield may be added to a format of a broadcast TWT parameter set field, as referenced in Table 3 above, which will not be repeated here.

The embodiments of the present disclosure provide a communication method. Optionally, the method may be performed by an AP, in which the AP may be a scheduling device of the R-TWT SP. The method may include:
receiving a first frame, in which the first frame includes R-TWT adjustment information, the R-TWT adjustment information indicates an adjustment operation performed by an STA on the R-TWT SP, and the adjustment operation includes extending the R-TWT SP or shortening the R-TWT SP; and a broadcast TWT information subfield of the first frame includes an R-TWT wake duration adjustment present indicator bit, and
the R-TWT wake duration adjustment present indicator bit is set to a fifth value to indicate that the first frame includes the R-TWT adjustment information. If the fifth value is set to 1, that is, an R-TWT wake duration adjustment present indicator bit of the first frame is set to 1, it indicates that a broadcast TWT parameter set field includes the R-TWT wake duration adjustment subfield; if the R-TWT wake duration adjustment present indicator bit is set to 0, it indicates that the R-TWT wake duration adjustment subfield is not included in the broadcast TWT parameter set field. A format of the broadcast TWT parameter set field is as shown in the Table 5 above, which will not be repeated here.

The embodiments of the present disclosure provide a communication method. Optionally, the method may be performed by an AP, in which the AP may be a scheduling device of the R-TWT SP. The method may include:
receiving a first frame, in which the first frame includes R-TWT adjustment information, the R-TWT adjustment information indicates an adjustment operation performed by an STA on the R-TWT SP, and the adjustment operation includes extending the R-TWT SP or shortening the R-TWT SP, and the first frame includes nominal minimum TWT wake duration information, and
the nominal minimum TWT wake duration information includes: a sum of a preset minimum TWT wake duration and a time indicated by the R-TWT adjustment information; or a difference between a preset minimum TWT wake duration and a time indicated by the R-TWT adjustment information; or a difference between a preset minimum TWT wake duration and an R-TWT timeout. The preset minimum TWT wake duration is an initial minimum TWT wake duration. When the STA determines that the R-TWT SP is too short or too long and adjusts the R-TWT SP, the STA may send a TWT setup frame to its associated scheduling device and adjust a value of the nominal minimum TWT wake duration in a broadcast TWT parameter set field (where a broadcast TWT ID corresponding to the TWT setup frame is located).

The embodiments of the present disclosure provide a communication method. Optionally, the method may be performed by an AP, in which the AP may be a scheduling device of the R-TWT SP. The method may include:
receiving a first frame, in which the first frame includes R-TWT adjustment information, the R-TWT adjustment information indicates an adjustment operation performed by an STA on the R-TWT SP, and the adjustment operation includes extending the R-TWT SP or shortening the R-TWT SP.

Optionally, the method includes:
sending a sixth frame, in which the sixth frame includes an R-TWT timeout.

Optionally, the sixth frame is a management frame including an R-TWT parameter set field or an EHT operation field.

Optionally, a broadcast TWT information subfield of the sixth frame includes an R-TWT timeout present indicator bit; and

the R-TWT timeout present indicator bit is set to a fourth value to indicate that the sixth frame includes the R-TWT timeout.

Optionally, the R-TWT adjustment information is carried in an R-TWT parameter set field.

Optionally, a broadcast TWT information subfield of the first frame includes an R-TWT wake duration adjustment present indicator bit; and

the R-TWT wake duration adjustment present indicator bit is set to a fifth value to indicate that the first frame includes the R-TWT adjustment information.

Optionally, the first frame includes nominal minimum TWT wake duration information, and
the nominal minimum TWT wake duration information includes: a sum of a preset minimum TWT wake duration and a time indicated by the R-TWT adjustment information; or a difference between a preset minimum TWT wake duration and a time indicated by the R-TWT adjustment information; or a difference between a preset minimum TWT wake duration and the R-TWT timeout.

Optionally, the first frame includes a TWT setup frame.

In the embodiments of the present disclosure, the AP receives the first frame, obtains the R-TWT adjustment information carried in the first frame, and determines the adjustment operation performed by the STA on the R-TWT SP, and the adjustment operation includes extending the R-TWT SP or shortening the R-TWT SP. On the one hand, after an initial R-TWT SP ends, the STA transmitting the low-latency service may not send any frame to its associated AP. If the initial R-TWT SP is too short, the low-latency service transmitted between the STA and the AP may be interrupted, which may degrade a communication quality. On the other hand, communication of other non-low-latency service is not performed in the initial R-TWT SP. If the initial R-TWT SP is too long, communication resources may be wasted. Therefore, by extending or shortening the R-TWT SP, the STA enhances the transmission quality of the low-latency service and avoids waste of the communication resources.

Referring to FIG. 4, based on a same principle as the method in the embodiments of the present disclosure, the embodiments of the present disclosure also provide an electronic device. The electronic device is an STA, including:

a determining module 401, configured to determine a first frame, in which the first frame includes R-TWT adjustment information, the R-TWT adjustment information indicates an adjustment operation performed by the STA on an R-TWT SP, and the adjustment operation includes extending the R-TWT SP or shortening the R-TWT SP; and
a sending module 402, configured to send the first frame.

Optionally, the determining module 401 is configured to:
extend the R-TWT SP in at least one of following cases:
receiving a second frame sent by a scheduling device of the R-TWT SP within last N IFSs before an end of the R-TWT SP, in which the second frame includes an ACK frame, a block ACK frame or a multi-station block ACK frame, and a More Data subfield of the second frame is set to a first value;
not receiving a third frame sent by the scheduling device of the R-TWT at the end of the R-TWT SP, in which the third frame includes an ACK frame, a block ACK frame or a multi-station block ACK frame; or
receiving a fourth frame sent by the scheduling device before the end of the R-TWT SP, in which an EOSP subfield of a QoS control field of the fourth frame is set to a second value.

Optionally, the determining module 401 is configured to:
extend the R-TWT SP based on a preset R-TWT adjustment time.

Optionally, the determining module 401 is configured to:
shorten the R-TWT SP in at least one of following cases:
receiving a fifth frame sent by a scheduling device of the R-TWT SP within last M IFSs before an end of the R-TWT SP, in which the fifth frame includes an ACK frame, a block ACK frame or a multi-station block ACK frame, and a More Data subfield of the fifth frame is set to a third value; or
not transmitting or receiving data in a preset R-TWT timeout before the end of the R-TWT SP.

Optionally, shortening the R-TWT SP includes:
shortening the R-TWT SP based on a preset R-TWT adjustment time; or
ending the R-TWT SP in advance when the R-TWT timeout expires.

Optionally, the electronic device includes:
a timeout receiving module, configured to receive a sixth frame, in which the sixth frame includes the R-TWT timeout.

Optionally, the sixth frame is a management frame including an R-TWT parameter set field or an EHT operation field.

Optionally, a broadcast TWT information subfield of the sixth frame includes an R-TWT timeout present indicator bit; and
the R-TWT timeout present indicator bit is set to a fourth value to indicate that the sixth frame includes the R-TWT timeout.

Optionally, the R-TWT adjustment information is carried in an R-TWT parameter set field.

Optionally, a broadcast TWT information subfield of the first frame includes an R-TWT wake duration adjustment present indicator bit; and
the R-TWT wake duration adjustment present indicator bit is set to a fifth value to indicate that the first frame includes the R-TWT adjustment information.

Optionally, the first frame includes nominal minimum TWT wake duration information, and
the nominal minimum TWT wake duration information includes: a sum of a preset minimum TWT wake duration and a time indicated by the R-TWT adjustment information; or a difference between a preset minimum TWT wake duration and a time indicated by the R-TWT adjustment information; or a difference between a preset minimum TWT wake duration and the R-TWT timeout.

Optionally, in the case that the second frame sent by the scheduling device of the R-TWT SP is received within the last N IFSs before the end of the R-TWT SP, the nominal minimum TWT wake duration information includes the sum of the preset minimum TWT wake duration and the time indicated by the R-TWT adjustment information;
in the case that the third frame sent by the scheduling device is not received before the end of the R-TWT SP, the nominal minimum TWT wake duration information includes a sum of the preset minimum TWT wake duration and the R-TWT timeout; or
in the case that the fourth frame sent by the scheduling device of the R-TWT SP is received before the end of the R-TWT SP, the nominal minimum TWT wake duration information includes a sum of the preset minimum TWT wake duration and the R-TWT timeout.

Optionally, in the case that the fifth frame sent by the scheduling device of the R-TWT SP is received within the last M IFSs before the end of the R-TWT SP, the nominal minimum TWT wake duration information includes the difference between the preset minimum TWT wake duration and the time indicated by the R-TWT adjustment information; or
in the case that data is not transmitted in the preset R-TWT timeout before the end of the R-TWT SP, the nominal minimum TWT wake duration information includes the difference between the preset minimum TWT wake duration and the R-TWT timeout.

Optionally, the first frame includes a TWT setup frame.

The embodiments of the present disclosure also provide a communication device, applied to an STA, including:
a frame determining module, configured to determine a first frame, in which the first frame includes R-TWT adjustment information, the R-TWT adjustment information indicates an adjustment operation performed by the STA on an R-TWT SP, and the adjustment operation includes extending the R-TWT SP or shortening the R-TWT SP; and
a frame sending module, configured to send the first frame.

The device also includes other modules of the electronic device as described in the embodiments above, which will not be repeated here.

Referring to FIG. 5, based on a same principle as the method in the embodiments of the present disclosure, the embodiments of the present disclosure also provide an electronic device. The electronic device is an AP, including:
a receiving module 501, configured to receive a first frame, in which the first frame includes R-TWT adjustment information, the R-TWT adjustment information indicates an adjustment operation performed by an STA on an R-TWT SP, and the adjustment operation includes extending the R-TWT SP or shortening the R-TWT SP.

Optionally, the electronic device includes:
a timeout sending module, configured to send a sixth frame, in which the sixth frame includes an R-TWT timeout.

Optionally, the sixth frame is a management frame including an R-TWT parameter set field or an EHT operation field.

Optionally, a broadcast TWT information subfield of the sixth frame includes an R-TWT timeout present indicator bit; and
the R-TWT timeout present indicator bit is set to a fourth value to indicate that the sixth frame includes the R-TWT timeout.

Optionally, the R-TWT adjustment information is carried in an R-TWT parameter set field.

Optionally, a broadcast TWT information subfield of the first frame includes an R-TWT wake duration adjustment present indicator bit; and
the R-TWT wake duration adjustment present indicator bit is set to a fifth value to indicate that the first frame includes the R-TWT adjustment information.

Optionally, the first frame includes nominal minimum TWT wake duration information, and
the nominal minimum TWT wake duration information includes: a sum of a preset minimum TWT wake duration and a time indicated by the R-TWT adjustment information; or a difference between a preset minimum TWT wake duration and a time indicated by the R-TWT adjustment information; or a difference between a preset minimum TWT wake duration and the R-TWT timeout.

Optionally, the first frame includes a TWT setup frame.

The embodiments of the present disclosure also provide a communication device, applied to an AP, including:
a frame receiving module, configured to receive a first frame, in which the first frame includes R-TWT adjustment information, the R-TWT adjustment information indicates an adjustment operation performed by an STA on an R-TWT SP, and the adjustment operation includes extending the R-TWT SP or shortening the R-TWT SP.

The device also includes other modules of the electronic device as described in the embodiments above, which will not be repeated here.

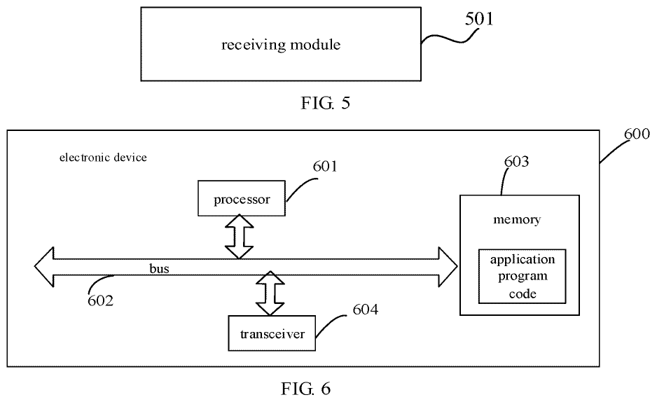

In an optional embodiment, the embodiments of the present disclosure also provide an electronic device. As shown in FIG. 6, the electronic device 600 shown in FIG. 6 may be a server, including: a processor 601 and a memory 603. The processor 601 is connected to the memory 603, for example, via a bus 602. Optionally, the electronic device 600 may further include a transceiver 604. It should to be noted that there may be more than one transceiver 604 in a practical application, and a structure of the electronic device 600 does not constitute a limitation on the embodiments of the present disclosure.

The processor 601 may be a central processing unit (CPU), a general-purpose processor, a digital signal processor (DSP), an application specific integrated circuit (ASIC), a field-programmable gate array (FPGA), or other programmable logic device, a transistor logic device, a hardware component, or any combination thereof. It may implement or execute various illustrative logical blocks, modules, and circuits described in combination with content of the present disclosure. The processor 601 may also be a combination performing a computing function, for example, a combination of one or more microprocessors, a combination of a DSP and a microprocessor, etc.

The bus 602 may include a pathway for transmitting information among above components. The bus 602 may be a peripheral component interconnect (PCI) bus, an extended industry standard architecture (EISA) bus, or the like. The bus 602 may be divided into an address bus, a data bus, a control bus, and the like. For ease of description, in FIG. 6, the bus 602 is shown as one thick line, which does not mean there is only one bus or one type of bus.

The memory 603 may be a read-only memory (ROM) or other type of static storage device capable of storing static information and instructions, a random access memory (RAM) or other types of dynamic storage devices capable of storing information and instructions, an electrically erasable programmable read-only memory (EEPROM), a compact disc read-only memory (CD-ROM), other optical disc storage (including a compressed disc, a laser disc, an optical disc, a digital versatile disc, a blu-ray disc, etc.), a magnetic disk storage medium, other magnetic storage devices, or any other medium capable of carrying or storing program code in a form of instructions or data structures and accessible by a computer, but is not limited thereto.

The memory 603 is used to store application program code for executing the solution of the present disclosure and is controlled for execution by the processor 601. The processor 601 is configured to execute the application program code stored in the memory 603 to implement content shown in above method embodiments.

The electronic device includes, but is not limited to, a mobile terminal, such as a mobile phone, a laptop, a digital broadcast receiver, a personal digital assistant (PDA), a personal digital assistant (PAD), a portable media player (PMP), a vehicle-mounted terminal (e.g., a vehicle-mounted navigation terminal), etc., and a fixed terminal, such as a digital television (TV), a desktop computer, etc. The electronic device shown in FIG. 6 is merely an example and should not impose any limitations on a function and a scope of application of the embodiments of the present disclosure.

The server in the present disclosure may be an independent physical server, or a server cluster or a distributed system including a plurality of physical servers, or a cloud server providing basic cloud computing services, such as a cloud service, a cloud database, cloud computing, a cloud function, a cloud storage, a network service, a cloud communication, a middleware service, a domain name service, a security service, a content delivery network (CDN), big data, and an artificial intelligence platform. The terminal may be a smartphone, a tablet computer, a laptop, a desktop computer, a smart speaker, a smartwatch, etc., but is not limited thereto. The terminal and the server may be directly or indirectly connected via a wired or wireless communication means, which is not limited by the present disclosure herein.

The embodiments of the present disclosure provide a computer-readable storage medium for storing a computer program. When the computer program is executed on a computer, the computer is caused to implement corresponding content in above method embodiments.

It should be understood that although steps in flowcharts of accompanying drawings are displayed in order indicated by arrows, these steps are not necessarily executed in the order indicated by the arrows. Unless explicitly stated herein, there are no strict sequential constraints on execution of these steps, and they may be executed in another order. Moreover, at least some of the steps in the flowcharts of the accompanying drawings may include a plurality of sub-steps or stages, which are not necessarily executed at a same time but may be executed at different times. An execution order is not necessarily performed sequentially, but may be performed alternately or in rotation with other steps or at least some of the sub-steps or stages of other steps.

It should to be noted that above computer-readable storage medium in the present disclosure may be a computer-readable signal medium, a computer-readable storage medium, or any combination of them. The computer-readable storage medium may be, but is not limited to, an electrical, a magnetic, an optical, an electromagnetic, an infrared, or a semiconductor system, apparatus, or device, or any combination of them. More specific examples of computer-readable storage media may include, but are not limited to, an electrical connection with one or more wires, a portable computer disk, a hard disk, a random-access memory RAM, a ROM, an erasable programmable read-only memory (EPROM or flash memory), an optical fiber, a portable CD-ROM, an optical storage device, a magnetic storage device, or any suitable combination of them. In the present disclosure, the computer-readable storage medium may be any tangible medium that includes or stores a program which may be used by or in connection with a system, an apparatus, or a component for executing instructions. In the present disclosure, the computer-readable signal medium may include a propagated data signal in a baseband or as a part of a carrier wave, in which computer-readable program code is carried. The propagated data signal may take various forms, including but not limited to an electromagnetic signal, an optical signal, or any suitable combination of them. The computer-readable signal medium may also be any computer-readable storage medium other than a computer-readable storage medium, which may transmit, propagate, or transmit a program which may be used by or in connection with the system, the apparatus, or the device for executing the instructions. The program code carried on the computer-readable storage medium may be transmitted using any appropriate medium, including but is not limited to, a wire, an optical cable, a radio frequency (RF), etc., or any suitable combination of them.

The above computer-readable storage medium may be included in the electronic device, or may exist independently without being installed in the electronic device.

The above computer-readable storage medium carries one or more programs. When the one or more programs are executed by the electronic device, the electronic device is caused to implement the method shown in the above embodiments.

According to one aspect of the present disclosure, a computer program product or a computer program is provided. The computer program product or the computer program includes computer instructions stored in the computer-readable storage medium. A processor of a computer reads the computer instructions from the computer-readable storage medium and executes the computer instructions, so that the computer may implement the method in above various optional implementations.

Computer program code for executing operations of the present disclosure may be written in one or more programming languages or a combination of them. These programming languages include an object-oriented programming language such as Java, Smalltalk, and C++, and a conventional procedural programming language such as a “C” language or a similar programming language. The program code may be executed entirely on a user computer, partly on a user computer, as a dependent software package, partly on a user computer and partly on a remote computer, or entirely on a remote computer or a server. In a scenario involving the remote computer, the remote computer may be connected to the user computer via any type of network, including a local area network (LAN) or a wide area network (WAN), or to an external computer (e.g., via an Internet using an Internet service provider).

The flowcharts and block diagrams in the accompanying drawings show an architecture, a function, and an operation of possible implementations of the system, the method, and the computer program product according to various embodiments of the present disclosure. In this regard, each block in the flowchart or the block diagram may represent a module, a program segment, or a part of the code that includes one or more executable instructions for implementing a specified logical function. It also should to be noted that, in some optional implementations, the functions noted in the blocks may occur different from an order noted in the drawings. For example, two blocks shown in succession may, in fact, be executed concurrently, or the blocks may sometimes be executed in a reverse order, depending on a function involved. It also should to be noted that each block of the block diagrams and/or the flowcharts, and a combination of the blocks in the block diagrams and/or the flowcharts, may be implemented by a special-purpose hardware-based system that performs a specified function or operation, or by a combination of special-purpose hardware and computer instructions.

The modules in the embodiments of the present disclosure may be implemented in software or hardware. A name of the module does not, in some cases, constitute a limitation on the module itself. For example, A module may also be described as “A module for performing a B operation”.

The above description is merely preferred embodiments of the present disclosure and an explanation of a technical principle applied. Those skilled in the art should understand that a scope of the present disclosure is not limited to technical solutions formed by a specific combination of above technical features, but also includes other technical solutions formed by any combination of the above technical features or their equivalent features without departing from the principle of the present disclosure. For example, a technical solution formed by replacing above features with technical features, including (but not limited to) those having similar functions, disclosed in the present disclosure.

1. A communication method, performed by a station (STA), comprising:
determining a first frame, wherein the first frame comprises restricted target wake time (R-TWT) adjustment information, the R-TWT adjustment information indicates an adjustment operation performed by the STA on an R-TWT service period (SP), and the adjustment operation comprises extending the R-TWT SP or shortening the R-TWT SP; and
sending the first frame.

2. The method of claim 1, further comprising:
extending the R-TWT SP in at least one of the following cases:
receiving a second frame sent by a scheduling device of the R-TWT SP within last N interframe spaces (IFSs) before an end of the R-TWT SP, wherein the second frame comprises an acknowledgement (ACK) frame, a block ACK frame or a multi-station block ACK frame, and a More Data subfield of the second frame is set to a first value;
not receiving a third frame sent by the scheduling device of the R-TWT at the end of the R-TWT SP, wherein the third frame comprises an ACK frame, a block ACK frame or a multi-station block ACK frame; or
receiving a fourth frame sent by the scheduling device before the end of the R-TWT SP, wherein an end of service period (EOSP) subfield of a quality of service (QoS) control field of the fourth frame is set to a second value.

3. The method of claim 1, wherein extending the R-TWT SP comprises:
extending the R-TWT SP based on a preset R-TWT adjustment time.

4. The method of claim 1, further comprising:
shortening the R-TWT SP in at least one of following cases:
receiving a fifth frame sent by a scheduling device of the R-TWT SP within last M IFSs before an end of the R-TWT SP, wherein the fifth frame comprises an ACK frame, a block ACK frame or a multi-station block ACK frame, and a More Data subfield of the fifth frame is set to a third value; or
not transmitting or receiving data in a preset R-TWT timeout before the end of the R-TWT SP.

5. The method of claim 4, wherein shortening the R-TWT SP comprises:
shortening the R-TWT SP based on a preset R-TWT adjustment time; or
ending the R-TWT SP in advance when the R-TWT timeout expires.

6. The method of claim 4, further comprising:
receiving a sixth frame, wherein the sixth frame comprises the R-TWT timeout, and the sixth frame is a management frame comprising an R-TWT parameter set field or an extreme high throughput (EHT) operation field;
wherein a broadcast TWT information subfield of the sixth frame comprises an R-TWT timeout present indicator bit; and the R-TWT timeout present indicator bit is set to a fourth value to indicate that the sixth frame comprises the R-TWT timeout.

7-8. (canceled)

9. The method of claim 1, wherein the R-TWT adjustment information is carried in an R-TWT parameter set field.

10. The method of claim 1, wherein a broadcast TWT information subfield of the first frame comprises an R-TWT wake duration adjustment present indicator bit; and
the R-TWT wake duration adjustment present indicator bit is set to a fifth value to indicate that the first frame comprises the R-TWT adjustment information.

11. The method of claim 2, wherein the first frame comprises nominal minimum TWT wake duration information, and
the nominal minimum TWT wake duration information comprises: a sum of a preset minimum TWT wake duration and a time indicated by the R-TWT adjustment information; or a difference between the preset minimum TWT wake duration and the time indicated by the R-TWT adjustment information; or a difference between the preset minimum TWT wake duration and the R-TWT timeout.

12. The method of claim 11, wherein
the nominal minimum TWT wake duration information comprises the sum of the preset minimum TWT wake duration and the time indicated by the R-TWT adjustment information in at least one of the following cases:
in the case that the second frame sent by the scheduling device of the R-TWT SP is received within the last N IFSs before the end of the R-TWT SP, the nominal minimum TWT wake duration information comprising the sum of the preset minimum TWT wake duration and the time indicated by the R-TWT adjustment information;
in the case that the third frame sent by the scheduling device is not received before the end of the R-TWT SP, the nominal minimum TWT wake duration information comprising a sum of the preset minimum TWT wake duration and the R-TWT timeout; or
in the case that the fourth frame sent by the scheduling device of the R-TWT SP is received before the end of the R-TWT SP, the nominal minimum TWT wake duration information comprising a sum of the preset minimum TWT wake duration and the R-TWT timeout.

13. The method of claim 11, wherein the nominal minimum TWT wake duration information comprises the difference between the preset minimum TWT wake duration and the time indicated by the R-TWT adjustment information in at least one of the following cases:
in the case that the fifth frame sent by the scheduling device of the R-TWT SP is received within the last M IFSs before the end of the R-TWT SP, the nominal minimum TWT wake duration information comprising the difference between the preset minimum TWT wake duration and the time indicated by the R-TWT adjustment information; or
in the case that data is not transmitted in the preset R-TWT timeout before the end of the R-TWT SP, the nominal minimum TWT wake duration information comprising the difference between the preset minimum TWT wake duration and the R-TWT timeout.

14. The method of claim 1, wherein the first frame comprises a TWT setup frame.

15. A communication method, performed by an access point (AP), comprising:
receiving a first frame, wherein the first frame comprises restricted target wake time (R-TWT) adjustment information, the R-TWT adjustment information indicates an adjustment operation performed by a station (STA) on an R-TWT service period (SP), and the adjustment operation comprises extending the R-TWT SP or shortening the R-TWT SP.

16. The method of claim 15, further comprising:
sending a sixth frame, wherein the sixth frame comprises an R-TWT timeout and the sixth frame is a management frame comprising an R-TWT parameter set field or an extreme high throughput (EHT) operation field;
wherein a broadcast TWT information subfield of the sixth frame comprises an R-TWT timeout present indicator bit; and the R-TWT timeout present indicator bit is set to a fourth value to indicate that the sixth frame comprises the R-TWT timeout.

17-18. (canceled)

19. The method of claim 15, wherein the R-TWT adjustment information is carried in an R-TWT parameter set field.

20. The method of claim 15, wherein a broadcast TWT information subfield of the first frame comprises an R-TWT wake duration adjustment present indicator bit; and
the R-TWT wake duration adjustment present indicator bit is set to a fifth parameter value to indicate that the first frame comprises the R-TWT adjustment information.

21. The method of claim 15, wherein the first frame comprises nominal minimum TWT wake duration information, and
the nominal minimum TWT wake duration information comprises: a sum of a preset minimum TWT wake duration and a time indicated by the R-TWT adjustment information; or a difference between the preset minimum TWT wake duration and the time indicated by the R-TWT adjustment information; or a difference between the preset minimum TWT wake duration and the R-TWT timeout.

22. The method of claim 15, wherein the first frame comprises a TWT setup frame.

23-24. (canceled)

25. A station (STA), comprising:
a processor; and
a memory storing instructions executable by the processor,
wherein the processor is configured to:
determine a first frame, wherein the first frame comprises restricted target wake time (R-TWT) adjustment information, the R-TWT adjustment information indicates an adjustment operation performed by the STA on an R-TWT service period (SP), and the adjustment operation comprises extending the R-TWT SP or shortening the R-TWT SP; and
send the first frame

26. (canceled)

27. An access point (AP), comprising:
a processor;
a memory storing instructions executable by the processor,
wherein the processor is configured to implement the method of claim 15.
